(19) United States
(12) Patent Application Publication
(10) Pub. No.: US 2011/0239133 A1
(43) Pub. Date: Sep. 29, 2011

(54) SHARED RESOURCE COMPUTING COLLABORATION SESSIONS MANAGEMENT

(75) Inventors: James S. Duffus, Seattle, WA (US); Wilhelm R. Schmieder, Snoqualmie, WA (US)

(73) Assignee: MICROSOFT CORPORATION, Redmond, WA (US)

(21) Appl. No.: 12/749,037

(22) Filed: Mar. 29, 2010

(51) Int. Cl. G06F 3/048

(52) U.S. Cl. 715/753

(57) ABSTRACT

The administration of a shared resource computing environment involves the establishment of direct input/output (I/O) connections between a plurality user interfaces and a single computing device. Each of the user interfaces provides a corresponding computer user with access to the single computing device. One or more desktop sessions are launched in the shared resource computing environment that is implemented on the single computing device. The administration of the shared resource computing environment also includes providing the computer users with concurrent access to the one or more desktop sessions, and managing interaction of the computer users in the one or more desktop sessions.

### BACKGROUND

Computer users predominately use personal computing devices, such as desktop computers, to independently handle computing tasks or produce work products. Each of these personal computing devices are generally equipping with its own independent operating system and software applications. However, in some instances, computer users may also desire to work cooperatively on the same computing task or share in a common computing experience. For example, the computer users may desire to concurrently edit the same text document, or work on the same multimedia presentation. In such instances, computer users generally use networking hardware and software that are installed on their personal computing devices to achieve such goals.

In some instances, the use of networking hardware and software may present technical or logistical barriers. For example, a network-based environment that enables such concurrent collaboration on a computing task or sharing in a common computing experience may be based on the use of expensive networking hardware or software, complex and ever changing network security and encryption technology, and/or constant maintenance by network administration personnel. Moreover, the sharing of a common computing task over a network-based environment may have a considerable computing resource burden, as data, files, and states associated with a computing task may have to be saved on an initial computing device, transferred over a network, and then recreated on a recipient computing device.

### SUMMARY

Described herein are techniques for the administration of a shared resource computing environment that enables multiple users to collaborate on the same computing task or share in a common computing experience without reliance on a network environment. The shared resource computing environment may be implemented on a single computing device, such as a personal computer. The single computing device may provide multiple users with access to various desktop sessions. Accordingly, the single computing device may support multiple user interfaces, wherein each user interface enables a corresponding computer user to simultaneously provide user input and receive data output via one or more desktop sessions that are running on the single computing device. For example, the user interface for each user computer may include a display, a keyboard, and/or a mouse that are directly coupled to the single computing device.

The multiple users may collaborate on the same computing task or share in a common computing experience via one or more desktop sessions of the shared resource environment, and/or may each be working in separate sessions. The one or more desktop sessions may be running on the single computing device. Each desktop session is an environment, which may be presented as a window, in which multiple users may interact with each other by concurrently entering user input, as well as view the outcome generated by the user input, and/or the reactions of other computer users to the input. For example, a desktop session may enable the multiple users to simultaneously edit a document together, cooperatively solve a puzzle, or play a multi-player game together.

The administration of the shared resource computing environment may involve controlling computer user access to the one or more desktop sessions. For example, the administration of the shared resource computing environment may include selection and placement of computer users into desktop sessions, moving computer users to different desktop sessions, removing users from desktop sessions, creating new desktop sessions, ending desktop sessions, saving desktop sessions, and/or resuming desktop sessions.

In at least one embodiment, the administration of a shared resource computing environment includes the establishment of direct input/output (I/O) connections between a plurality user interfaces and a single computing device. Thus, each of the user interfaces may provide a corresponding computer user with access to the single computing device. Further, one or more desktop sessions are launched in the shared resource computing environment that is implemented on the single computing device. The administration of the shared resource computing environment also includes providing the computer users with concurrent access to the one or more desktop sessions, and managing the interaction of the computer users in the one or more desktop sessions.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different Figs. indicates similar or identical items.

FIG. 1 is a block diagram that illustrates an example shared resource computing architecture that enables the administration of multiple computer users that are sharing multiple desktop sessions on a single computing device.

FIG. 2 is a block diagram that illustrates selected components for the performance and administration of shared resource computing.

FIG. 3 is an example user interface screen of an administrative session for the administration of multiple desktop sessions of the shared resource computing environment.

FIG. 4 is an example user interface screen of a desktop environment for a computer user to interact with the multiple desktop sessions of the shared resource computing environment.

FIG. 5 is a flow diagram that illustrates an example process for establishing and managing a shared resource computing environment.

FIG. 6 is a flow diagram that illustrates an example process for the administration of multiple computing users for the concurrent sharing of multiple desktop sessions.

FIG. 7 is a flow diagram that illustrates an example process for the administration of multiple desktop sessions for the concurrent sharing of multiple desktop sessions.

FIG. 8 is a block diagram that illustrates a representative computing device that may implement a shared resource computing architecture and the administration of shared resource computing.

### DETAILED DESCRIPTION

This disclosure is directed to the administration of a shared resource computing environment that is implemented on a single computing device. The single computing device may provide multiple users with access to various desktop sessions. Accordingly, the single computing device may support multiple user interfaces, wherein each user interface enables a corresponding computer user to, concurrently with other users, provide user input and receive data output via a desktop session that is running on the single computing device. Thus, the shared resource computing environment, as implemented on the single computing device, may enable multiple computer users to concurrently collaborate on the same computing task or share in the same computing experience without reliance on networking hardware. For example, the shared resource computing environment may be implemented without network interface cards, hubs, routers, servers, bridges, switches, and other components commonly associated with communications over the Internet, as well without reliance on software applications and protocols for communication over the Internet.

In various embodiments, the administration of the shared resource computing environment may include selection and placement of computer users into desktop sessions, moving computer users to different desktop sessions, removing users from desktop sessions, creating new desktop sessions, ending desktop sessions, saving desktop sessions, and/or resuming desktop sessions.

Thus, the cost and effort that may be associated with maintaining a network environment for the purpose of concurrent collaboration on a computing task or share in a common computing experience may be eliminated. Further, since the computer users are connected to the single computing device via direct IO connections, security issues commonly associated with communications via a computer network, such as issues data interception, network intrusion, or computer worms and virus, may be avoided. For example, data encryption may become unnecessary in a scenario where the user interfaces of the multiple computer users are connected to the single computing device via USB connections, due to the limited opportunities for data interception. Moreover, the burden associated with saving data, files, and states that are associated with sharing a common computing environment via a network infrastructure may also be reduced or eliminated. In other examples, because of the physical proximity that direct IO connections may provide to computer users that share a single computing device, network security measures such as establishment of share and directory permissions, having user accounts on the same domain, or transmitting invitation keys over a network to establish secured connections, may become unnecessary.

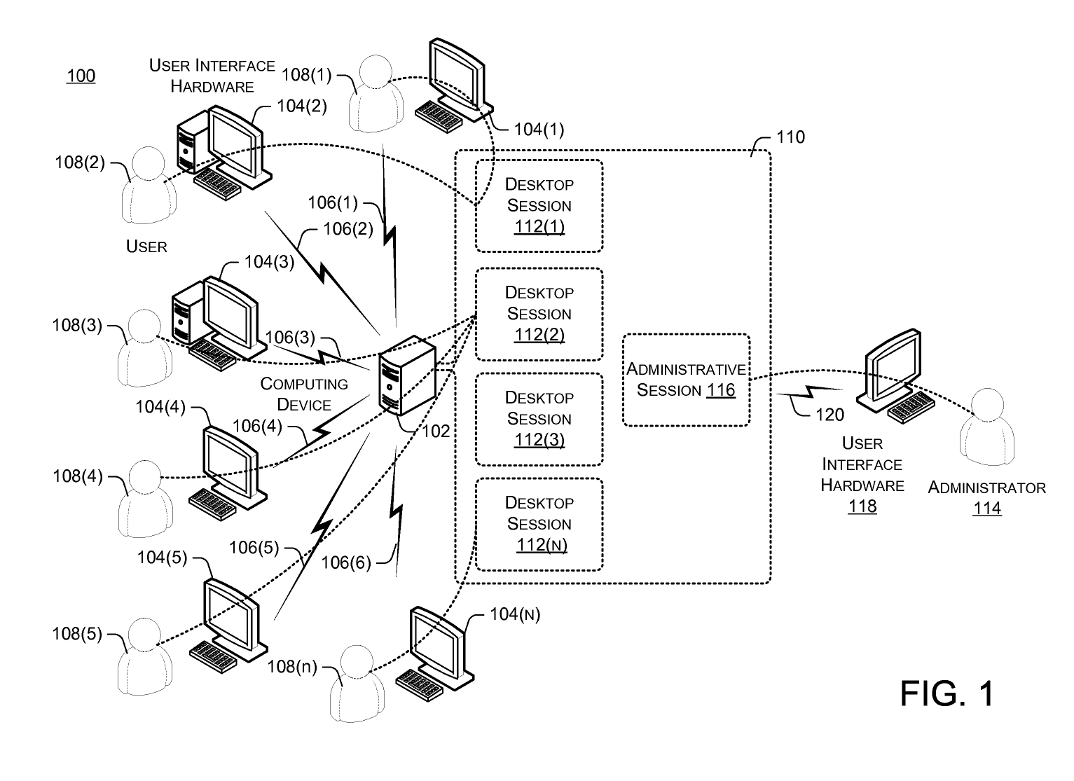

Various examples for administrating a shared resource computing environment in accordance with the embodiments are described below with reference to FIGS. 1-8.

### Example Architecture

FIG. 1 illustrates an example shared resource computing architecture 100 that enables the administration of multiple computer users that are sharing multiple desktop sessions on a single computing device.

The example architecture 100 may be implemented on a computing device 102. The computing device 102 may be capable of simultaneously receiving a plurality of user inputs from multiple user interfaces, as well as providing processed data to the users via the multiple user interfaces. In various embodiments, the computing device 102 may be a desktop computer, a laptop computer, a multimedia computer, or the like. The multiple user interfaces may include user interface hardware 104(1)-104(n), where the actual number of user interface hardware 104(1)-104(n) may vary. The multiple user interfaces may be connected to the computing device 102 via corresponding direct I/O connections 106(1)-106(n). Moreover, the user interface hardware 104(1)-104(n) may enable corresponding users 108(1)-108(n) to interact with the computing device 102.

In various embodiments, the user interface hardware 104(1)-104(n) may include at least one “peripheral” interface and/or at least one “thin-client” interface. In the embodiment shown in FIG. 1, The “peripheral” user interface hardware 104(1) may include a display device (e.g., a monitor) that presents data to the corresponding computer user 108(1), as well as one or more input devices (e.g., a keyboard and/or mouse) that transfers input from the computer user 108(1) to the computing device 102. However, in other embodiments, the data input devices of the user interface hardware 104(1) may include, but are not limited to, combinations of one or more of keypads, mouse devices, touch screens, microphones, cameras, speech recognition packages, and any other suitable devices or other electronic/software. The “peripheral” user interface hardware 104(1) may further include a local storage, such as a hard drive, flash memory, solid state drive, and/or the like.

The user interface hardware 104(1) may be connected to the computing device 102 via a direct input/output (I/O) connection 106(1). The direct I/O connection 106(1) may be any wired serial or parallel data transfer connection, such as a universal serial bus (USB) connection, a DisplayPort connection, IEEE 1394 connections, and/or the like.

The user interface hardware 104(2) may be a “thin-client” computing device, such as a computing device that is running a limited operating system. The “thin-client” computing device may include a display component (e.g., LCD monitor) and a user input component (e.g., keyboard, mouse, and/or other components as describe above). The display component and the user input component of the “thin-client” computing may be connected to a basic processor and memory architecture that is capable of receiving, processing, storing, transmitting, and displaying data. The basic processor and memory architecture of the “thin-client” may be connected to the computing device 102 via direct input/output (I/O) connection 106(2). The direct I/O connection 106(2) may be any wired serial or parallel data transfer connection, a universal serial bus (USB) connection, a DisplayPort connection, IEEE 1394 connections, and/or the like.

Thus, “direct I/O connection,” as used herein, refers to a connection between two devices that is implemented without the use of network components, such as network interface cards, hubs, routers, servers, bridges, switches, and other components commonly associated with communications over the Internet, as well as without reliance on software applications and protocols that are typically used for communication over the Internet. In the embodiment shown in FIG. 1, the user interface hardware 104(4)-104(n) are also “peripheral” interfaces, while 104(3) is also a “thin-client” interface. However, it will be appreciated that the various computing devices described herein may nevertheless have software and/or hardware that provide networking capabilities.

In various embodiments, the computing device 102 may provide a shared resource computing environment 110. The users 108(1)-108(n) may access one or more desktop sessions, such as the desktop sessions 112(1)-112(n). Each of the desktop sessions 112(1)-112(n) may be a workspace where a single computer user may engage in a computing task, or a plurality of computer users may collaborate on the same computing task or share in a common computing experience. In some embodiments, the desktop sessions 112(1)-112(n) may be remote desktop sessions from of a windows-based operating system. In other embodiments, the desktop sessions 112(1)-112(n) may be virtual machine sessions provided by a virtual machine that is operating on the computing device 102.

For example, as shown in FIG. 1, the desktop session 112(1) may be running a multi-user word processing application that enables computer users (e.g., computer users 108(1) and 108(2)), to concurrently edit a document. As used herein, “concurrently” may refer to the simultaneous or the sequential input of data to produce a result. The desktop session 112(2) may be running a math application that enables a second plurality of computer users (e.g., computer users 108(3)-108(5)), to share the task of solving a math puzzle in the desktop session 112(2). Further, the computer user 108(n) may be working independently on a multimedia presentation in the desktop session 112(n), while the desktop session 112(3) may be inactive.

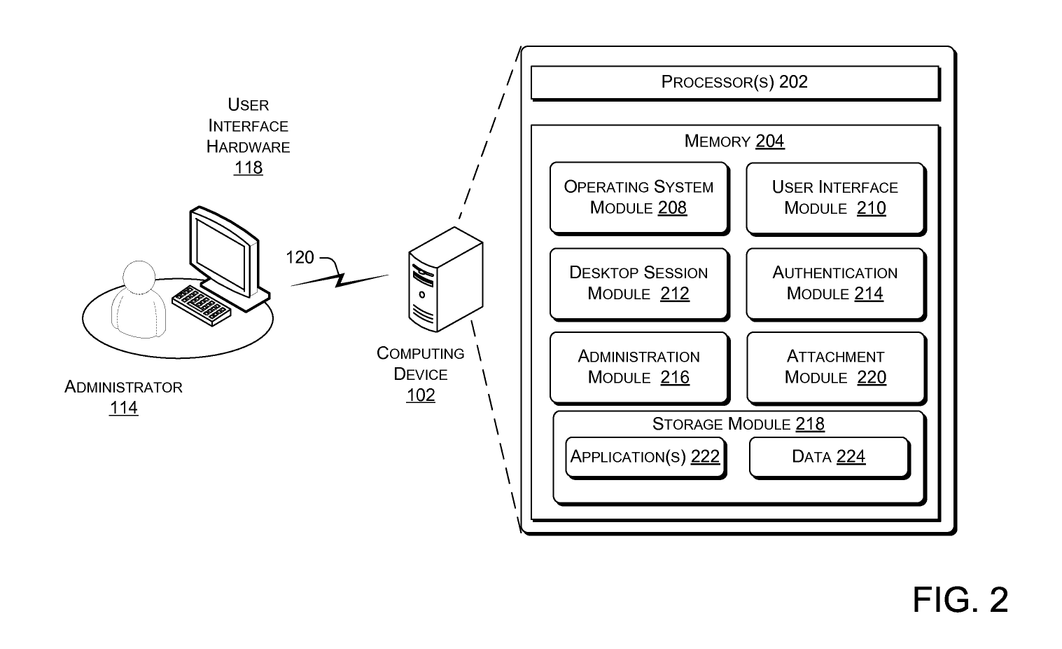

The desktop sessions of the shared resource computing environment 110, such as the desktop sessions 112(1)-112(n), may be administered by an administrator 114 using an administrative session 116. The administrator 114 may interact with the administrative session 116 using a user interface hardware 118 that is connected to the computing device via a direct I/O connection 120. While the user interface hardware 118 is illustrated in the embodiment shown in FIG. 1 as a “peripheral” interface, the user interface hardware 118 may also be a “thin-client” interface in other embodiments. Moreover, as further described with respect to FIG. 2, the administrative session 116 may enable the administrator 114 to perform a variety of tasks related to computer user and desktop session management and control. Such tasks may include, but are not limited to, selecting and placing computer users into desktop sessions, moving computer users to different desktop sessions, removing users from desktop sessions, and/or recording and playing user interaction with the desktop sessions. Additionally, as further described below, the administrative session 116 may further allow the administrator 114 to create new desktop sessions, terminate desktop sessions, save desktop sessions, suspend desktop sessions and/or resume desktop sessions. In some embodiments, the administrator 114 may be one of the computer users of the desktop sessions 112(1)-112(n), such as computer user 108(1).

### Example Components

FIG. 2 is a block diagram that illustrates selected components for the performance and administration of shared resource computing. The components may be implemented on the computing device 102, which may include one or more processors 202 and memory 204.

The components may be stored in the memory 204. The memory 204 may include volatile and/or nonvolatile memory, removable and/or non-removable media implemented in any method or technology for storage of information, such as computer-readable instructions, data structures, program modules or other data. Such memory may include, but is not limited to, random accessory memory (RAM), read-only memory (ROM), electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and is accessible by a computer system. Further, the components may be in the form of routines, programs, objects, and data structures that cause the performance of particular tasks or implement particular abstract data types.

In various embodiments, the components may include an operating system module 208, a user interface module 210, a desktop session 212, an authentication module 214, an administration module 216, a storage module 218, and an attachment module 220.

The operating system module 208 may include at least one operating system that enables the computing device 102 to receive data via various inputs (e.g., user controls, network interfaces, and/or memory devices), and process data using the one or more processors 108 to generate output. The operating system may also include a display function that presents the output (e.g., displays the graphics on an electronic display, stores data in memory, transmits data to another electronic device, etc.). The operating system may further provide resources and services for the implementation and execution of various applications, such as the one or more applications 222 stored in the storage module 218. In various embodiments, the operating system may include a window-based graphical user interface (GUI) architecture that presents a “desktop” as the primary environment for computer users to interact with the operating system and applications. Additionally, the operating system may include other functions that perform various other functions generally associated with an operating system.

In some embodiments, the operating system module 208 may also include platform virtualization functionalities that enable the computing device 102 to perform hypervisor functionalities, that is, host multiple operating systems concurrently with the same underlying hardware resource.

The user interface module 210 may enable a plurality of computer users to concurrently interact with the computing device 102. In various embodiments, the user interface module 210 may concurrently or sequentially receive a plurality of user inputs from various computer users via input devices, such as the various input components of the user interface hardware 104(1)-104(n). In turn, the user interface module 210 may transfer the plurality of user inputs to the other modules (e.g., operating system module 208). The user interface module 210 may further enable output data that are generated by the various modules of the computing device 102 to be provided to the plurality computer users via data output device, such as the various output components of the user interface hardware 104(1)-104(n). For example, the modules of the computing device 102 may use an operating system of the operating system module 208 to pass data outputs to the user interface module 210, so that the data output may be transferred to a computer user via an output device.

In various embodiments, rather than being a separate module, the user interface module 210 may be an integral part of the operating system module 208. Alternatively, the user interface module 210 may be a built-in component of the one or more operating systems that are stored in the operating system module 208.

The desktop session module 212 may generate the shared resource computing environment 110 that includes one or more desktop sessions, such as the desktop sessions 112(1)-112(n) shown in FIG. 1. As described with respect to FIG. 1, each of the desktop sessions may be a workspace where a single computer user may engage in a computing task, or a plurality of computer users may concurrently collaborate on the same computing task or share in a common computing experience. In various embodiments, the desktop session module 212 may present each of the desktop sessions as a “window” in a desktop of a windows-based operating system. The multiple computer users 108(1)-108(n) may concurrently interact with the one or more applications 222 within each of the desktop sessions. Thus, in some embodiments, an application 222 may have the capability to distinguish and process the concurrent inputs of different users. For example, one of the applications 222 may be a two-player game that receives the simultaneous inputs of two computer users and handles the inputs accordingly.

However, in other embodiments, an application 222 in a desktop session may rely on the desktop session module 212 to handle the simultaneous inputs from the multiple computer users. Thus, in such embodiments, the desktop session module 212 may have the capability to transform simultaneous user inputs into sequential user inputs prior to providing the transformed user inputs to the application 222 in the desktop session.

The authentication module 214 may authenticate one or more computer users, such as the computer users 108(1)-108(n), as the computer users attempt to access the shared resource computing architecture 100. In various embodiments, the authentication module 214 may authenticate the computer users via authentication credentials. Such authentication credentials may include, but are not limited to, a user name, a password, an electronic certificate, a biometric characteristic, and/or the like. Following authentication, the authentication module 214 may grant a computer user access, that is, log the computer user into the shared resource computing environment 110 generated by the desktop session module 212. In at least one embodiment, rather than being a separate module, the authentication module 214 may be part of the desktop session module 212 or the operating system module 208. Once a user is authenticated to the resource computing environment 100, the authentication module 214 may further cause the user interface module 210 to associate the user interface hardware from which the user provided the authentication with the authenticated user. For example, when the user 108(1) authenticates to the computing resource environment 100 via the user interface hardware 104(1), the authentication module 214 may associate the user interface hardware 104(1) with the user 108(1).

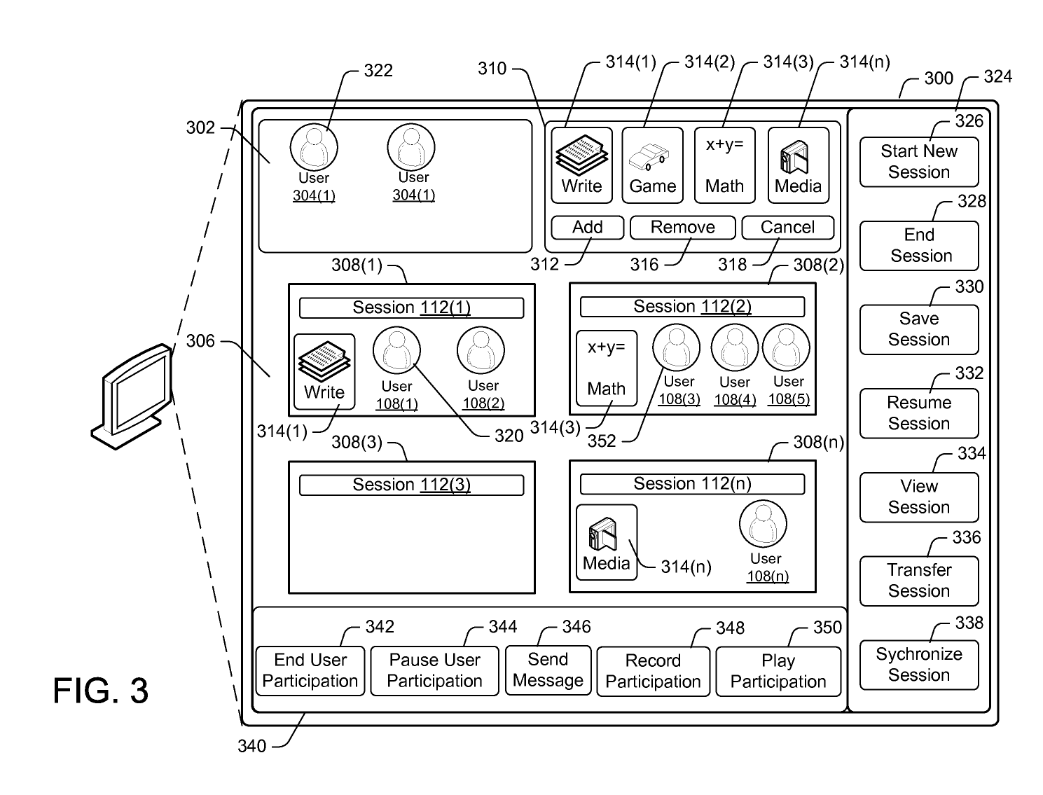

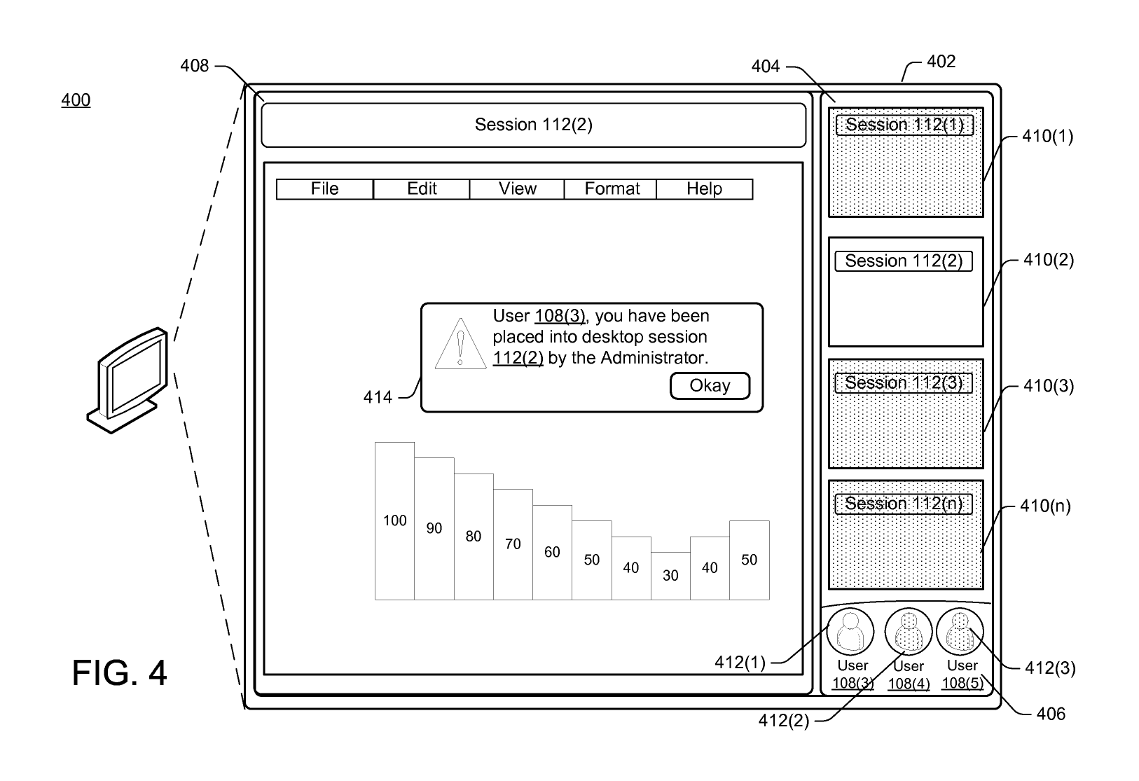

The administration module 216 may enable the administrator 114 to manage the desktop sessions 112(1)-112(n), as well as manage the interaction of the users 108(1)-108(n) with the desktop sessions. In various embodiments, the administration module 216 may generate an administrative session, such as the administrative session 116 described in FIG. 1, which enables the administrator 114 to interact with the administration module 216. The operation of the administrative session 116 is described with respect to FIGS. 3 and 4.

FIG. 3 is an example user interface screen 300 of the administrative session 116 for the administration of multiple desktop sessions of the shared resource computing environment. The example screen 300 may be generated by the administration module 216 and display on the output component of the user interface hardware 118 as shown in FIG. 1. In various embodiments, the administrator 114 may interact with the selectable portions and buttons of the administrative session 116 via an input device component (e.g., click of a mouse button) of the user interface hardware 118.

As shown in the user interface screen 300, administrative session 116 generated by the administrative module 214 may include an idle user display portion 302 that displays computer users that have access to the shared resource computing environment of the computing device 102. In various embodiments, the computer users (e.g., users 304(1)-304(2)) may appear in the idle user display portion 302 following authentication by the authentication module 214. In at least one embodiment, each of the authenticated users may be represented by a user representation. The user representation of a user may be in the form of an icon that is pre-selected by the user, or a photographical image of the user. Further, in some embodiments, the user representation may be accompanied by an alphanumeric text label, in which the text label may be an identifier (e.g., actual name, login name, identification number, and/or the like). However, in additional embodiments, the user representation may consist solely of a text label.

The administration session 116 may further include a session display portion 306. The session display portion 306 may display window representations that represent desktop sessions that are currently active. For example, as shown in the user interface screen 300, the desktop sessions 112(1)-112(n) are respectively represented by corresponding window representations 308(1)-308(n).

The administration session 116 may further include an application display portion 310. The application display portion 310 may display application icons that represent the applications 222 that can be used by the computer users in various desktop sessions. For example, as shown, the application icons may include a word processing application icon 314(1), a game application icon 314(2), a math application icon 314(3), and a multimedia creation application icon 314(n), where each application icon represents the corresponding application that is stored in the storage module 218. The application display portion 310 may also include a plurality of buttons 310-318. In various embodiments, the add button 312 may enable the administrator 114 to add additional programs to the application display portion 310, so that additional applications may be used with the desktop sessions 112(1)-112(n). For example, the administrator 114 may activate (e.g., click) the add button 312 to bring up a control menu that enables the administrator to add another application.

Further, the remove button 316 may enable the administrator 114 to remove one or more of the applications 222 from the application display portion 310. The cancel button 318 may enable the administrator 114 to abort any addition or removal that affects the applications 222 listed in the application display portion 310.

Accordingly, the idle user display portion 302, the session display portion 306, and the application display portion 310, may be enable administrator 114 to interface with the administration module 216.

In at least one embodiment, the administrator may place a computer user into a desktop session by selecting (e.g., clicking) and dragging a graphical and/or textual representation of the computer user into a window representation that represents the desktop session. For example, as shown in the user interface screen 300, the administrator 114 has selected and placed computer users 108(1) and 108(2) into the window representation 308(1), which corresponds to desktop session 112(1). The administrator 114 has also selected and placed computer users 108(3)-108(5) into the window representation 308(2), which corresponds to desktop session 112(2). Likewise, the computer user 108(n) has been placed into window representation 308(n), which corresponds to desktop session 308(n). The placement of a computer user (e.g., computer user 108(1)) into a desktop session (e.g., desktop session 112(1)) may cause the administration module 216 to command the user interface module 214 to pass user input from the user interface hardware (e.g., user interface hardware 104(1)) associated with the computer user into the desktop session, as well as send data output from the desktop session to the associated user interface hardware.

Moreover, the administrator 114 may activate an application 222 for usage in a desktop session by selecting and dragging a corresponding application icon into a window representation that represents the desktop session. For example, as shown in the user interface screen 300, the administrator 114 may select and place application icon 314(1) into the window representation 308(1) that represents desktop session 112(1). In this way, the computer users 108(1) and 108(2) may use the corresponding word processing application in the desktop session 112(1). Likewise, the administrator 114 may activate a math puzzle application for use by the users 108(3)-108(5) by placing the application icon 314(3) into the window representation 308(2) that corresponds to the desktop session 112(2). Further, the administrator 114 may also activated a multimedia creation application for usage by the computer user 108(n) by placing the application icon 314(n) into the window representation 308(n). In various embodiments, when an application is capable of being run in multiple instances, a copy of the application icon for the application will remain visible in the application display portion 310 even after the application icon has been placed into a desktop session. For example, the application icon 314(2) appears in the application display portion 110 despite the fact that the corresponding word processing application is being used in the desktop session 112(1). However, when an application is a single instance application (e.g., an application that is limited to use by one user), the application icon that corresponds to the application may disappear when the application is selected for usage. For example, one of the applications 222 that corresponds to application icon 314(2) may be a single instance game application. Thus, when the application icon 314(2) is placed into the desktop session 112(3), the application icon 213(2) may disappear from the application display portion 310.

The administrator 114 may also switch the computer users of a desktop session to a different application using the application icons 314(1)-314(n). For example, if the administrator 114 determines that the computer users 108(3)-108(5) have made sufficient progress with the math puzzle application represented by the application icon 314(3), the administrator 114 may stop the computer users 108(3)-108(5) from working on the math puzzle application by selecting and moving the application icon 314(3) from the window representation 308(2) back to the application display portion 310. Subsequently, the administrator 114 may enable the computer users 108(3)-108(4) to interact with a game application by selecting and moving the application icon 314(2) into the window representation 308(2). Thus, by enabling the administrator 114 to move application icons in such a manner, the administrative module 216 may facilitate the switch of the computer users of various desktop sessions to different applications.

The administrative module 216 may also enable the administrator 114 to change the computer users in each desktop session. In various embodiments, the administrator 114 may make such changes by selecting and dragging the appropriate user representation that is displayed in the administrative session 116. For example, if the administrator 114 desires to reassign the computer user 108(1) from working on the document in the desktop session 112(1) to working on the math puzzle in the desktop session 112(2), the administrator 114 may select the user representation 320 of the computer user 108(1), and move the user representation 320 from the window representation 308(1) to the window representation 308(2).

Further, if the administrator 114 desires to add a new computer user to a desktop session, the administrator 114 may move a user representation of the computer user from the idle user portion 302 to the appropriate desktop session. For example, if the administrator 114 desires to add the computer user 304(1) to the desktop session 112(3), the administrator 114 may select the user representation 322 of the computer user 304(1) to the window representation 308(3).

Likewise, if the administrator 114 desires to stop a computer user from participation in a desktop session, the administrator 114 may select and move the user representation of the computer user from the corresponding window representation to the idle user display portion 302.

The administration session 116 may further include a desktop session control portion 324 that enables the administrator 114 to manage desktop sessions. The desktop control session portion 324 may include a new session button 326, an end session button 328, a save session button 330, a resume session button 332, a view session button 334, a transfer session button 336, and a synchronize session button 338.

The new session button 326 may enable the administrator 114 to start a new desktop session in the shared resource computing environment 110 by activating (e.g., clicking) the button. The activation of the new session button 326 may also cause the administration module 216 to spawn a new window representation in the session display portion 306 of the administrative session 116. In various embodiments, the new window representation may include menu options that enable the administrator 114 to name the representation, move the representation within the session display portion 306, sort the window representation in relation to other window representations, resize the new window representation, and/or the like.

The end session button 328 may enable the administrator 114 to end an existing desktop session. For example, if the administrator 114 desires to end the desktop session 112(1), the administrator 114 may select the window representation 308(1), and then activate (e.g., click) the end session button 328. Subsequently, the desktop session 112(1) may disappear from the session display portion 306. The activation of the end session button 328 for a desktop session may also cause the user representations of the computer users in the desktop session to reappear in the idle user portion 302. For example, when the desktop session 112(1) is terminated, the administration module 216 may cause the user representation 320 (and other user representations in the desktop session) to reappear in the idle user 302.

Likewise, in instances where the desktop session that is terminated includes an application 222 that is only capable of running in a single instance, the termination of the desktop session may cause the corresponding application icon to reappear in the application display portion 310. For example, if the application that is represented by the application icon 314(1) is a single instance word processing application, the termination of the desktop session 112(1) may cause the application icon 314(1) to reappear in the application display portion 310.

The save session button 330 may enable the administrator 114 to suspend an existing desktop session. In various embodiments, the suspension of an existing desktop session, such as the desktop session 112(1), may include saving data and states associated with the desktop session into a non-volatile portion of the memory 204, so that the desktop session may be resumed a later time. In various embodiments, the administrator 114 may suspend a desktop session by selecting (e.g., clicking) the desktop session and activating (e.g., clicking) the save session button 330.

In at least one embodiment, the activation of the save session button 330 may cause the administration module 216 to display menu options that enable the administrator 114 to create a name for the file that stores the data and states for the session, as well as a file directory path for the location of the saved file in the storage module 218. The data and states of the saved desktop session may be stored by the administration module 216 into the storage module 218 as part of the data 224. The administration module 216 may subsequently cause the application icon representing the saved desktop session to disappear from the session display portion 306, as well as simultaneously terminate all computer user access to the saved desktop session. However, in other embodiments, the administrator module 216 may continue to provide the computer users access to the saved desktop session, and any application in the saved desktop session, unless the administrator 114 activates the end session button 330. A repeat activation of the save session button 330 for the same desktop session may replace previously saved data and states of the session with the most current data and states.

The resume session button 332 may enable the administrator 114 to resume a previously saved desktop session. The resumption of the saved desktop session may include the reloading of the data and states of the previously save desktop session from the non-volatile portion of the memory 204 into a volatile portion of the memory 204 for processing by the one or more processors 202. In various embodiments, the activation of the resume session button 332 may bring up menu options that enable the administrator 114 to select and resume a saved desktop session from the storage module 218. Upon resumption, the corresponding window representation of the resumed desktop session may appear in session display portion 306. In some embodiments, a computer user that is logged into the shared resource computing environment 110 and was participating in the desktop session at the time the session was suspended may receive a notification from the administration module 216 on an output device (e.g., display) that the desktop session has resumed. Further, the computer user may be prompted to rejoin the resumed desktop session. Similarly, a computer user of the saved session who is not logged into the shared resource computing environment 110 may be prompted to rejoin the resumed desktop session following authentication to the shared resource computing environment 110.

The view session button 334 may enable the administrator 114 to view or monitor computer user interactions in a desktop session. In various embodiments, the administrator 114 may view a desktop session by selecting a session, such as the desktop session 112(1), from the session display area, and activating (e.g., clicking) the view session button 334. The activation of the view session button 332 may replace the session display portion 306 with a “live” view of the desktop session. The “live” view may show the real-time interaction of the one or more computer users with each other, and/or the interaction of at least one computer user with an application that is running in the desktop session being viewed. In some embodiments, the administration module 216 may further enable the administrator 114 to participate in the desktop session that the administrator 114 is viewing live via the view session button 334.

The transfer session button 336 may enable the administrator 114 to export a saved desktop session to another computing device. In various embodiments, the activation (e.g., clicking) of the transfer session button 336 may bring up an option menu that lists previously saved sessions and a list of available computing devices to receive one or more of the saved desktop session. In some embodiments, the available computing devices are devices that are connected to the computing device 102 via direct I/O connections. Accordingly, the administrator may use the option menu provided by the transfer session button 336 to transfer a saved desktop session to another computing device. In some embodiments, the computing device may be a server of a data center that is part of a cloud computing environment, or another computing device connected via a network connection.

The synchronize button 338 may enable the administrator 114 to synchronize two different versions of desktop sessions, such as a version of a desktop session that is saved on the computing device 102 and a version of the same desktop session that is saved on another computing device. In various embodiments, the activation (e.g., click) of the synchronize button 338 may bring up an option menu that lists one or more previously saved desktop sessions that are stored in the storage module 218 of the computing device 102. The administrator 114 may then select a desktop session from the list for synchronization. During the synchronization, the administration module 216 may attempt to detect a different saved version of the same desktop session. If the administration module 216 detects the different version, the administration module 216 may determine whether the detected version is more recent than the version that is selected from the list. For example, this determination may be made based on the time and/or each version was created or last saved. If the detected version is more recent, the administration module 216 may replaced the version that is on the computing device 102 with the more recent version. Otherwise, the administration module 216 may cause the administration session 116 to indicate that a newer of the desktop session is not found on the other computing device.

In alternative embodiments, the administration module 216 may perform the above-described synchronization of different versions of the same saved desktop session automatically by detecting each saved desktop session when a computing device is connected to the computing device 102 via the direct I/O connection, and performing the version comparison and applicable replacement for each saved desktop session when appropriate.

The administration session 116, as generated by the administration module 216, may further include a user control portion 340 that enables the administrator 114 to further manage the computer users 108-(1)-108(n). The user control portion 340 may include an end button 342, a pause button 344, a send message button 346, a record button 348, and a play button 350.

The end button 342 may enable the administrator 114 to end the participation of a user in a desktop session. Thus, in the example above in which the administrator 114 desires to end the participation of the computer user 108(1) in the desktop session 112(1), the administrator 114 may select the user representation 320 and activate (e.g., click) the end button 342 to end the participation of the computer user 108(1). In at least one embodiment, the activation of the end button 342 for the 108(1) may also automatically move the user representation 320 back to the idle user portion 302.

The pause button 344 may enable the administrator 114 to suspend and resume the participation of a computer user in a desktop session. For example, if the administrator is viewing the desktop session 112(2) in real-time, and determines that the computer user 108(3) is taking an incorrect approach to solving a math puzzle, the administrator 114 may temporarily suspend the computer user 108(3) from participating in the desktop session 112(2). The administrator 114 may accomplish this suspension by selecting the user representation 352 and activating (e.g., clicking) the pause button 344. Subsequently, the administrator 114 may allow the computer user 108(3) to resume participation in the desktop sessions 112(2) by selecting the user representation 108(3) and activating the pause button 344 for a second time. In various embodiments, the user representation of a computer user that is suspended via the pause button 344 may change appearance to indicate the computer user has been suspended. For example, the user representation 352 may appear “grayed out” when the computer user 108(1) is suspended, but revert to a default appearance when the administrator 114 allows the computer user 108(1) to resume participation in the desktop session 112(2). The activation of the pause button 344 for a computer user may cause the administration module 216 to prevent the user interface module 214 from passing user input from the user interface hardware associated with the computer user into the desktop session, as well as prevent the user interface module 214 from sending data output from the desktop session to the associated user interface hardware. In other words, the administration module 216 may prevent the user interface hardware associated with the computer user from communicating with the desktop session.

The send message button 346 may enable the administrator 114 to send messages to one or more of the computer users 108(1)-108(n) that are participating in the desktop sessions 112(1)-112(n). In various embodiments, the activation (e.g., clicking) of the send message button 346 may cause administration module 216 to provide an option menu to the administrator 114, in which the menu may enable the administrator 114 to send an email, send a text message, open an instant message session, and/or like, with one or more of the computer users. Accordingly, the second activation of the pause button 344 may cause the administration module 216 to command the user interface module 214 to pass user input from the user interface hardware associated with the computer user into the desktop session, as well as send data output from the desktop session to the associated user interface hardware.

The record button 348 may enable the administrator 114 to record the activities of the one or more computer users in a desktop session, such as one of the desktop sessions 112(1)-112(n). In some embodiments, the administrator 114 may record the activities of a particular user by selecting the computer user and activating (e.g., clicking) the record button 348. For example, the administrator may record the activities of the computer user 108(3) in the desktop session 308(2) by selecting the user representation 248 and activating the record button 348. In other embodiments, the administrator 114 may record the activities of all computer users in a desktop session by selecting an entire desktop session prior to activating the record button 348. For example, the administrator 114 may select the desktop session 308(2) for recording by clicking on a particular area (e.g., title bar) of the desktop session 112, and activating the record button 348. The recording of the activities of the one or more computer users in the desktop session may be stored in the storage module 218. In at least one embodiment, the activation of the record button 348 for a computer user or desktop session may also generate a menu option that enables the administrator 114 to provide an identifier (e.g., name, date, and/or time) for the recording.

The play button 350 may enable the administrator 114 to play recordings of the activities of the one or more computer users in a desktop session. In various embodiments, the activation (e.g., clicking) of the play button 350 may cause the administration module 216 to provide an option menu that list one or more available recordings by their identifiers. In this way, the administrator 114 may select one of the recordings for play. In such embodiments, the session display portion 306 may be replaced with a play view of the selected recording. In at least one embodiment, the administration module 320 may also provide play controls during the playback of the selected recording, such playback controls may include, but is not limited to, play, stop, pause, fast forward, rewind, slow playback, and/or fast playback.

FIG. 4 is an example user interface screen 400 of a desktop environment 402 for a computer user to interact with the multiple desktop sessions 112(1)-112(n) of the shared resource computing environment 110. The desktop environment 402 may be displayed on the user interface hardware 104(1)-104(n) via the one or more modules of the computing device 102. Thus, a plurality of the desktop environment 402 may enable multiple computer users, such as the computer users 108(1)-108(n), to collaborate on a computing task or share in a common computing experience. As shown, the desktop environment 402 may include a session display area 404, a user display area 406, and an application work area 408.

The session display area 404 may display one or more desktop sessions that are available in the shared resource computing environment 110. Thus, in at least one embodiment, as the administrator 114 adds or removes desktop sessions to the shared resource computing environment 110, the administration module 216 may update the desktop environment 402 via the user interface module 210. For example, as shown, the session display area 404 may display the desktop sessions 112(1)-112(n). Furthermore, the administration module 216 may cause the session display area 404 to identify the desktop session that the computer user is currently participating in via various adornments or indicators. For example, as shown in FIG. 3, the administration module 226 may indicate that desktop session 112(2) is the current active session by “graying out” the window representations 410(1) and 410(3)-410(n), and leaving window representation 410(2) unchanged.

In some embodiments of the shared resource computing environment 110, the administrator 114 may have the ability to assign a computer user into multiple desktop sessions. For example, the administrator 114 may be able to drag a user representation of a computer user (e.g., the computer user 108(1)) into both the desktop session 112(1) and the desktop session 112(2) from the user display portion 302. Accordingly, in such embodiments, the window representations 410(1)-410(n) may serve another purpose. Specifically, the computer user may have the ability to choose one of the desktop sessions to participate in by selecting (e.g., clicking) on one of the corresponding window representations 410(1)-410(n).

The user display area 406 may display one or more computer users that are participating in a desktop session. For example, the user display area 406 may show that users 108(3)-108(5) are currently participating in the desktop session 112(2) via the display of the corresponding graphical and/or textual representations 412(1)-412(3) in the user display area 406. In various embodiments, the user display area 406 may further indicate the computer user 108(3) currently has control of an application that is displayed in the application work area 308 via visual adornments, such as by “graying out” the user representations 412(2)-412(3). In some embodiments, the user representations in the user display area 406 may be used by a computer user to pass control of the application to another computer user. For example, the computer user 108(3) may then pass the control of the application to the computer user 108(4) by activating (e.g., clicking) the user representation 412(2). In such an example, the user representation 108(4) may no longer be “grayed out” when control of the application is passed to the computer user 108(4), while user representation 412(2) may become “grayed out” until one of the other computer user returns control of the application to the computer user 108(3). However, in other embodiments, the application in the application work area 408 may be capable of simultaneously accepting inputs from multiple users. Thus, no visual adornments of the user representations are provided in such applications. The computer users displayed in the user display area may change as the administrator 114 make changes via the administrative session 116.

The application work area 408 of the desktop environment 402 may enable a computer user to interact with an application that the administrator 114 assigned to the currently active desktop session. For example, as shown in the example user interface screen 400, the computer user 108(3) may be assigned to work on a math puzzle application. In various embodiments, the administration module 216 may make one or more status dialogue boxes appear in the application work area 408 to inform the computer user that the administrator 114 has made changes to the desktop sessions, computer user assigned to each desktop session, and/or application assigned to each desktop session. For example, as shown, the desktop environment 402 may display a dialogue box 414 that indicates that the computer user 108(3) has been placed into the desktop session 112(2) by the administrator 114. Nevertheless, it will be appreciated that a variety of other dialogue boxes may be displayed, such as dialogue boxes related to the addition of a new desktop session, the termination of a desktop session, the addition, removal, or reassignment of computer users to different desktop sessions, new messages from the administrator 114, and/or the like. In further embodiments, the application work area 408 may also pop up an instant message chat window when the administrator 114 initiates an instant message session using the administration session 116.

Returning to FIG. 2, as described above, the data storage module 218 may store data used by the shared resource computing environment 110. The data storage module 218 may store one or more applications 222 and the data 224. The applications 222 may be applications that are executed in the desktop sessions 112 of the shared resource computing environment 110. The data 224 may include data that are used by the various modules of the computing devices 102 to implement the shared resource computing environment 110. In various embodiments, the data 224 may include authentication data used by the authentication module 214, data and states of the desktop sessions as saved by the administration module 216, recordings of the interactions of the computer users with the desktop sessions, as well other data used for the operation of the shared resource computing environment 110. However, in some embodiments, the data 224 related to a particular computer user may also be alternatively and/or concurrently saved to a local storage of a “peripheral” user interface hardware associated with the computer user. For example, the data 224 related to the computer user 108(1) may be stored to, as well as subsequently retrieved from the local storage on the “peripheral” user interface hardware 104(1) by the one or more modules of the computing device 102.

In further embodiments, the attachment module 220 may enable the shared resource computing environment 110 of the computing device 102 to interface with one or more shared resource computing environments that are located on other similarly equipped computing devices. In such embodiments, the interface between the computing device 102 and each of the other computing devices may be accomplished via a direct I/O connection (e.g., USB, DisplayPort, IEEE 1394, etc.). Further, the attachment module 220 may allow the computing device 102 to act as a master control computing device over the other computing devices. Thus, the attachment module 220 may enable administrator 114 to use the administration module 226 to manage desktop sessions that are located in the shared resource computing environments of these other computing devices, as well as computer users that are connected to these other computing devices. Alternatively, the attachment module 220 may allow the computing device 102 to act as a “slave device” with desktop sessions that are controllable by another computing device.

### Example Processes

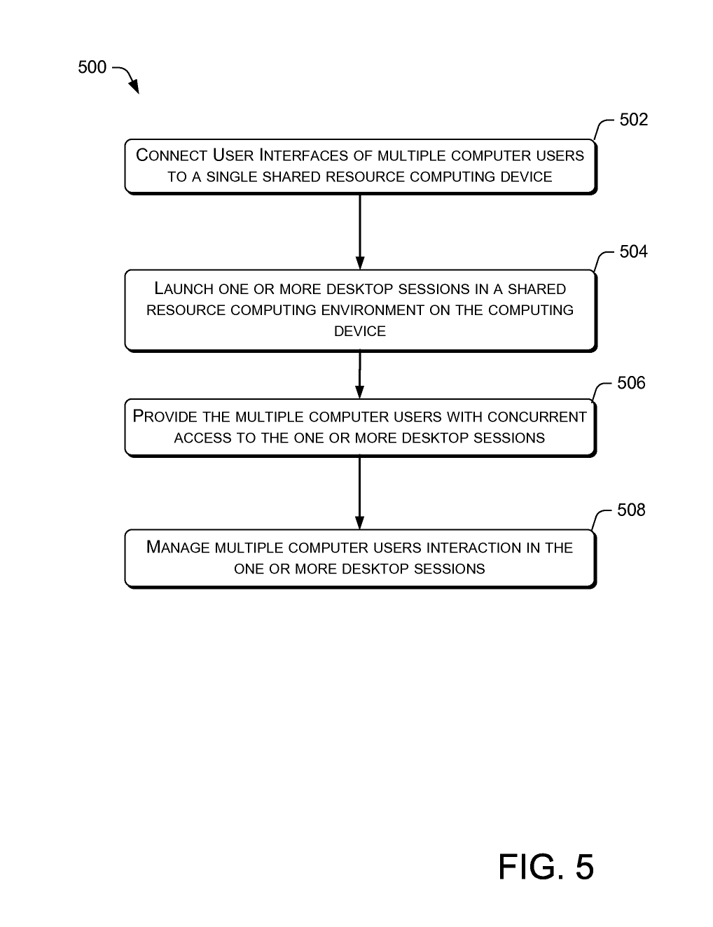

FIGS. 5-7 describe various example processes for implementing and administrating a shared resource computing environment. The example processes are described in the context of the environment of FIG. 1, but is not limited to that environment. The order in which the operations are described in each example process is not intended to be construed as a limitation, and any number of the described blocks can be combined in any order and/or in parallel to implement each process. Moreover, the blocks in the FIGS. 5-7 may be operations that can be implemented in hardware, software, and a combination thereof. In the context of software, the blocks represent computer-executable instructions that, when executed by one or more processors, cause one or more processors to perform the recited operations. Generally, the computer-executable instructions may include routines, programs, objects, components, data structures, and the like that cause the particular functions to be performed or particular abstract data types to be implemented.

FIG. 5 is a flow diagram that illustrates an example process 500 for establishing and managing a shared resource computing environment. At block 502, the user interfaces of multiple computer users 108(1)-108(n) may be connected to a single shared resource computing device 102. In various embodiments, each of the computer users 108(1)-108(n) may be provided with user interface hardware that connects directly to the computing device 102 via direct I/O connections. In this way, the computer user 108(1)-108(n) may access the shared computing resource computing environment 110 that is on the computing device 102.

At block 504, the administrator 114 may launch one or more desktop sessions, such as the desktop sessions 112(1)-112(n) in the shared resource computing environment 110 via the administrative session 116. Further, the administrator 114 may also use the administrative session 116 to provide one or more of the desktop sessions 112(1)-112(n) with applications that execute in those sessions.

At block 506, the administrator 114 may assign the multiple computer users 108(1)-108(n) into the one or more desktop sessions. In this way, at least some the computer users 108(1)-108(n) may concurrently collaborate on a computing task or share in a computing experience by simultaneously or sequentially providing user inputs to one or more applications executing in the desktop sessions 112(1)-112(n).

At block 508, the administrator 114 may use the administrative session 116 to further manage the interactions of the computer users 108(1)-108(n) with the one or more desktop sessions 112(1)-112(n). The administration session 116 may be generated by the administrator module 216. In various embodiments, the management may include, but are not limited to, select and place computer users into desktop sessions, move computer users to different desktop sessions, remove users from desktop sessions, and/or record and play user interaction with the desktop sessions. The administrative session 116 may further allow the administrator 114 to create new desktop sessions, terminate desktop sessions, save desktop sessions, suspend desktop sessions and/or resume desktop sessions.

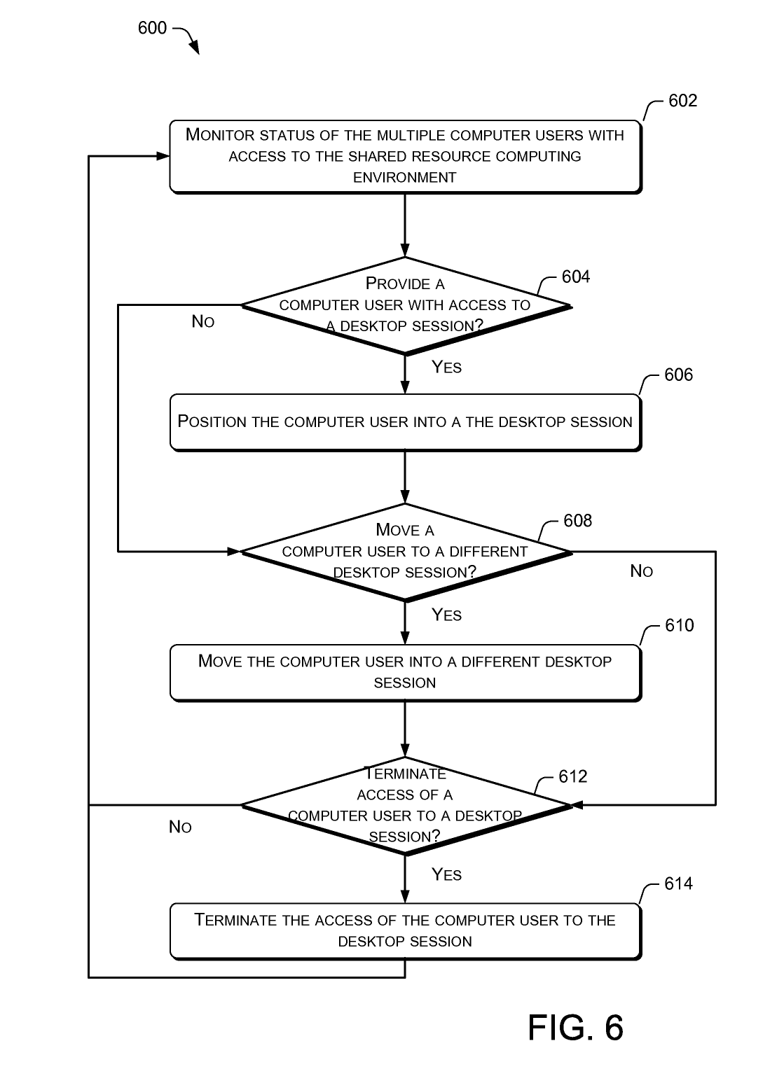

FIG. 6 is a flow diagram that illustrates an example process 600 for the administration of multiple computing users for the concurrent sharing of multiple desktop sessions. The example process 600 may further illustrate the block 508 of the example process 500.

At block 602, the administrator 114 may use the administration session 116 to monitor the status of the multiple computer users with access to the shared resource computing environment 110.

At decision block 604, the administrator 114 may determine whether a computer user, (e.g., computer user 108(1)), is to be provided with access to a desktop session. If the administrator 114 determines that the computer user is to be provided with access (“yes” at decision block 604), the process 600 may proceed to block 606.

At block 606, the administrator 114 may provide the computer user with access to a desktop session. In at least one embodiment, the administrator 114 may provide the access by positioning a user representation, (e.g., the user representation 320), from the idle user display portion 302 to a window representation, (e.g., window representation 308(1)), that corresponds to the desktop session. However, if the administrator 114 determines that the computer user is not be provided with desktop session access (“no” at decision block 604), the process 600 may proceed directly to decision block 608.

At decision block 608, the administrator 114 may determine whether the computer user that is in the desktop session is to be moved to a different desktop session. If the administrator 114 determines that the computer is to be moved (“yes” at decision block 608), the process 600 may proceed to block 610.

At block 610, the administrator 114 may move the computer user to a different desktop session. In various embodiments, the administrator may move the computer user by selecting and moving the user representation of the computer user from a first window representation (e.g., window representation 308(1)) to a second window representation (e.g., window representation 308(2)) in the administrative session 116. However, if the administrator 114 determines that the computer user is not to be moved (“no” at decision block 610), the process may proceed directly to decision block 612.

At decision block 612, the administrator 114 may determine whether the access of the computer user to the desktop session is to be terminated. If the administrator determines that the access of the computer user is to be terminated (“yes” at decision block 612), the process 600 may proceed to block 614.

At block 614, the administrator 114 may terminate the access of the computer user to the desktop session. In some embodiments, the administrator 114 may activate the end button 342 of the administrative session 116 terminate the participation of the computer user in the desktop session. In other embodiments, the administrator 114 may terminate access of the computer user (e.g., computer user 108(1)) by selecting and moving a corresponding user representation (e.g., user representation 320) back to the idle user display portion 302. Subsequently, the process 600 may loop back to block 602, as the administrator 114 may further monitor the status of the one or more computer users. However, if the administrator determines that the access of computer user is not to be terminated, the process 600 may directly loop back to block 602.

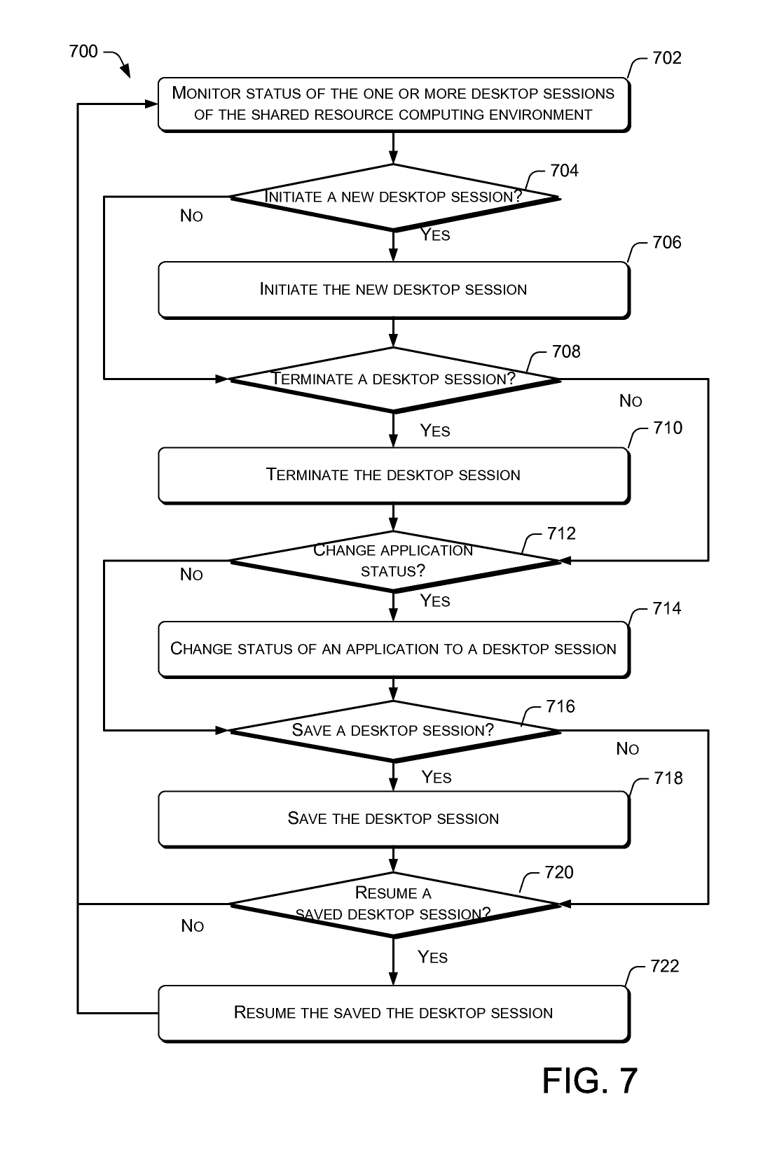

FIG. 7 is a flow diagram that illustrates an example process 700 for the administration of multiple desktop sessions for the concurrent sharing of multiple desktop sessions. The example process 700 may further illustrate the block 508 of the example process 500.

At block 702, the administrator 114 may use the administration session 116 to monitor the status of the desktop sessions in the shared resource computing environment 110.

At decision block 704, the administrator 114 may determine whether a new desktop session (e.g., desktop session 112(1)) is to be initiated. The administrator 114 may initiate a new desktop session so that multiple computer users may collaborate on a computing task or share in a common computing experience. If the administrator determines that the new desktop session is to be initiated (“yes” at decision block 704), the process 700 may proceed to block 706.

At block 706, the administrator 114 may initiate a new desktop session by activating the new session button 326 of the administrative session 116. In various embodiments, the administrator 114 may be prompted to provide a name for the new desktop session during the initiation. The new desktop session may appear in the session display portion 306 of the administrative session 116.

In at least one embodiment, the initiation of the desktop session may further include assigning an application to be executed in the initialized desktop session so that multiple computer users may concurrently interact with the application. However, if the administrator 114 determines that no new desktop session is to be initiated (“no” at decision block 706), the process 700 may proceed directly to decision block 708.

At decision block 708, the administrator 114 may determine whether a desktop session that is currently active in the shared resource computing environment 110 is to be terminated. If the administrator 114 determines that a desktop session is to be terminated (“yes” at decision block 708), the process 700 may proceed to block 710.

At block 710, the administrator 114 may terminate the desktop session by selecting the desktop session and activating the end session button 328 of the administrative session 116. In some embodiments, the termination of the desktop session may automatically move the user representations of the computer users associated with the terminated desktop session back into the idle user portion 302. Likewise, an application icon of a single instance application in the terminated desktop session may also automatically move back into the application display portion 310. However, if the administrator 114 determines that the no desktop session is to be terminated (“no” at decision block 710), the process 700 may proceed directly to decision block 712.

At decision block 712, the administrator 114 may determine whether to change a status of an application with respect to a desktop session. In various embodiments, the change in status may include one of assigning a new application for execution in the desktop session, terminating the execution of a currently active application in the desktop session, or implementing a different application to be executed in the desktop session. If the administrator 114 determines that the status of an application with respect to a desktop is to be changed (“yes” at decision block 712), the process 700 may proceed to block 714.

At block 714, the administrator 114 may perform an action to change the status of an application with respect to a desktop session. In various embodiments, the administrator 114 may assign a new application to a desktop session by selecting and moving an application icon from the application display portion 310 of the administrative session 116 to a window representation in the session display portion 306. The administrator 114 may terminate the execution of an application by moving an application from a window representation back to the application display portion 310. Further, the administrator 114 may implement a different application in the desktop session by performing a combination of such actions in the administration session 116. However, if the administrator 114 determines that no change in application status is to be made (“no” at decision block 714), the process 700 may proceed directly to decision block 716.

At decision block 716, the administrator 114 may determine whether a desktop session that is currently active in the shared resource computing environment 110 is to be saved. If the administrator 114 determines that a desktop session is to be saved (“yes” at decision block 716), the process 700 may proceed to block 718.

At block 718, the administrator 114 may save the desktop by selecting the desktop session and activating the save session button 236. The activation of the save session button 236 may cause the administrative module 216 to save the data and the states of the desktop session into the storage module 218. In some embodiments, the saving of the desktop session may automatically terminate the desktop session. However, in other embodiments, the administrator may use the end session button 328 to terminate the saved desktop session. However, if the administrator 114 determines that no desktop session is to be saved (“no” at decision block 716), the process 700 may proceed directly to decision block 720.

At decision block 720, the administrator 114 may determine whether a saved desktop session that is stored in the storage module 218 is to be resumed. If the administrator 114 determines that a saved desktop session is to be resumed (“yes” at decision block 720), the process 700 may proceed to block 722.

At block 722, the administrator 114 may resume the desktop session by activating the resume session button 332. In various embodiments, the activation of the resume session button 332 may cause an option menu to be displayed by the administrative session 116. In turn, the administrator 114 may select the saved desktop session from the storage module 218 via the option menu. The selected desktop session is then resumed by the administration module 216, that is, the data and states are restored into the shared resource computing environment 110 so that computer users may once again resume their participation in the resumed desktop session. Subsequently, the process 700 may loop back to block 702 as the administrator 114 may further monitor the status of the one or more desktop sessions. However, if the administrator 114 determines that no saved desktop session is to be resumed, the process 700 may loop directly back to block 702.

### Example Computing Device

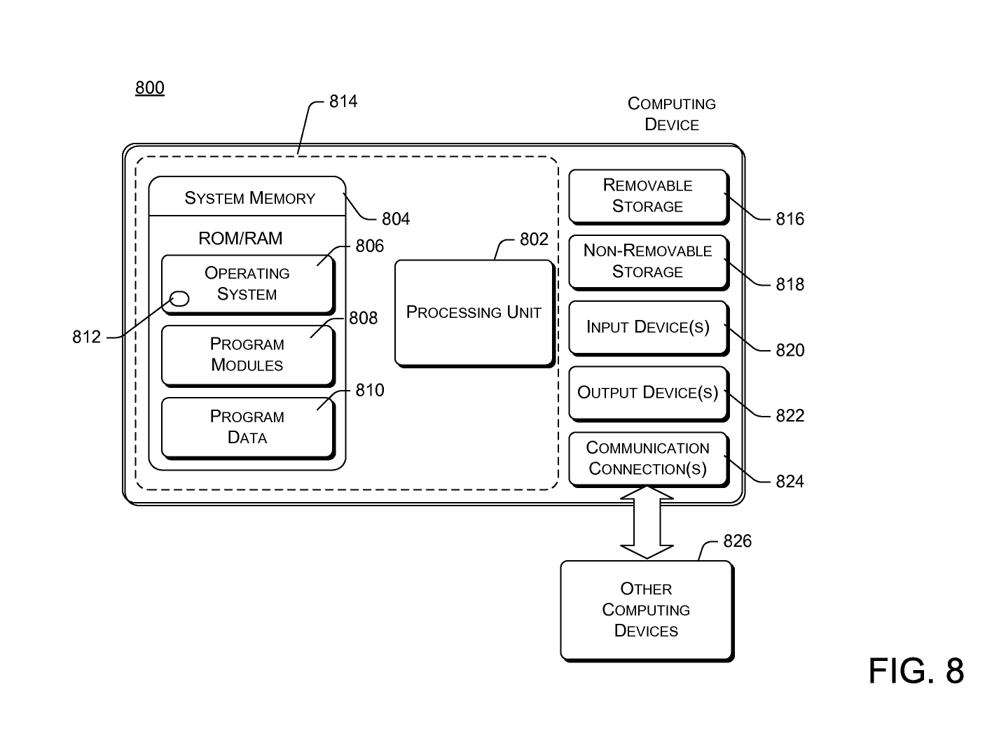

FIG. 8 illustrates a representative computing device 800 that may implement a shared resource computing environment 110. For example, the computing device 800 may be implemented as the computer device 102 described in FIG. 1. However, it will be readily appreciated that the techniques and mechanisms may be implemented in other computing devices, systems, and environments. The computing device 800 shown in FIG. 8 is only one example of a computing device and is not intended to suggest any limitation as to the scope of use or functionality of the computer and network architectures.

In at least one configuration, computing device 800 typically includes at least one processing unit 802 and system memory 804. Depending on the exact configuration and type of computing device, system memory 804 may be volatile (such as RAM), non-volatile (such as ROM, flash memory, etc.) or some combination thereof. System memory 804 may include an operating system 806, one or more program modules 808, and may include program data 810. The operating system 806 includes a component-based framework 812 that supports components (including properties and events), objects, inheritance, polymorphism, reflection, and provides an object-oriented component-based application programming interface (API), such as, but by no means limited to, that of the .NET™ Framework manufactured by the Microsoft® Corporation, Redmond, Wash. The computing device 800 is of a very basic configuration demarcated by a dashed line 814. Again, a terminal may have fewer components but may interact with a computing device that may have such a basic configuration.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by removable storage 816 and non-removable storage 818. Computer storage media may include volatile and nonvolatile, removable and non-removable media implemented in any method or technology for storage of information, such as computer readable instructions, data structures, program modules, or other data. System memory 804, removable storage 816 and non-removable storage 818 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by Computing device 800. Any such computer storage media may be part of device 800. Computing device 800 may also have input device(s) 820 such as keyboard, mouse, pen, voice input device, touch input device, etc. Output device(s) 822 such as a display, speakers, printer, etc. may also be included.

Computing device 800 may also contain communication connections 824 that allow the device to communicate with other computing devices 826, such as over a network. These networks may include wired networks as well as wireless networks. Communication connections 824 are some examples of communication media. Communication media may typically be embodied by computer readable instructions, data structures, program modules, etc.

It is appreciated that the illustrated computing device 800 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

The implementation and administration of a shared resource computing environment on a single computing device may enable multiple computer users to concurrently collaborate on the same computing task or share in the same computing experience without reliance on networking hardware such as, but not limited to, network interface cards, hubs, routers, servers, bridges, switches, and other components commonly associated with communications over the Internet, as well without reliance on the software applications and protocols for communication over the Internet.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

What is claimed is:

1. A computer readable medium of a single computing device storing computer-executable instructions that, when executed, cause one or more processors to perform acts comprising:
establishing direct input/output (I/O) connections to a plurality of user interfaces from the single computing device, each of the user interfaces including a display and one or more input devices providing a corresponding computer user with access to the single computing device;
launching one or more desktop sessions in a shared resource computing environment that is implemented on the single computing device;
providing the plurality of computer users with concurrent access to the one or more desktop sessions of the shared resource computing environment via the plurality of user interfaces; and
managing interaction of the plurality of computer users in the one or more desktop sessions.

2. The computer readable medium of claim 1, wherein the establishing the direct I/O connections includes establishing the direct I/O connections without using networking hardware or software components.

3. The computer readable medium of claim 1, wherein each of the direct I/O connections is a wired serial data transfer connection or a wired parallel data transfer connection.

4. The computer readable medium of claim 1, wherein each of the user interfaces includes a display and one or more input devices.

5. The computer readable medium of claim 1, wherein each of the user interfaces is a thin-client computing device that includes a display and one or more input devices.

6. The computer readable medium of claim 1, wherein the providing the plurality of computer users with concurrent access includes providing a computer user with access to multiple desktop sessions and receiving a user selection to participate in one of the multiple desktop sessions.

7. The computer readable medium of claim 1, wherein the providing the plurality of computer users with concurrent access includes providing at least one of simultaneous or sequential access to an application that is executing in a desktop session of the shared resource computing environment.

8. The computer readable medium of claim 1, wherein the managing includes at least one of:
moving a computer user from a first of the desktop sessions to a second desktop session of the shared computing resource environment;
suspending participation of the computer user in a desktop session of the shared computing resource environment by preventing a corresponding user interface of the computer user from communicating with the desktop session, the participation includes at least one of interaction between the computer user and at least one other computer user or interaction of the computer user with an application executing in the desktop session;
viewing in real time the participation of the computer user in the desktop session of the shared computing resource environment;
recording the participation of the computer user in the desktop session of the shared computing resource environment;
playing a saved recording of the participation of the computer user in the desktop session of the shared computing resource environment;
sending a message to the computer user that is participating in the desktop session of the shared computing resource environment; or
terminating the access of the computer user to the desktop session of the shared computing resource environment.

9. The computer readable medium of claim 1, wherein the managing includes at least one of:
launching another desktop session in the shared resource computing environment that is concurrently accessed by the plurality of computer users;
terminating a desktop session or an application in the desktop session of the shared resource computing environment;
saving data and states of a desktop session of the shared resource computing environment;
resuming a saved desktop session of the shared resource computing environment; or
switching the desktop session of the shared resource computing environment from executing a first application to executing a second application.

10. A computer implemented method, comprising:
under control of a single computing device configured with executable instructions,
establishing direct input/output (I/O) connections to a plurality of user interfaces from the single computing device, each of the user interfaces providing a corresponding computer user with access to the single computing device;
launching at least one desktop session in a shared resource computing environment that is implemented on the single computing device;
providing the plurality of computer users with concurrent access to an application that is executing in the at least one desktop session of the shared resource computing environment; and
managing interaction of the plurality of computer users in the at least one desktop session, the managing at least includes switching the at least one desktop session of the shared resource computing environment from executing the application to executing another application.

11. The method of claim 10, wherein the managing further includes at least one of:
terminating the at least one desktop session or an application in the at least one desktop session;
saving data and states of the at least one desktop session of the shared resource computing environment; or
resuming the at least one desktop session of the shared resource computing environment that is saved.

12. The method of claim 10, wherein the establishing the direct I/O connections includes establishing the direct I/O connections without using networking hardware or software components.

13. The method of claim 10, wherein each of the user interfaces includes a display and one or more input devices.

14. The method of claim 10, wherein each of the user interfaces is a thin-client computing device that includes a display and one or more input devices.

15. The method of claim 10, wherein the launching includes launching a plurality of desktop sessions in the shared resource computing environment.

16. The method of claim 10, wherein the providing the plurality of computer users with concurrent access includes providing at least one of simultaneous or sequential access to the application via the plurality of user interfaces.

17. The method of claim 10, wherein the managing further includes at least one of:
suspending participation of the computer user in the at least one desktop session of the shared computing resource environment, the participation includes at least one of interaction between the computer user and at least one other computer user or interaction of the computer user with the application executing in the at least one desktop session;
viewing in real time the participation of the computer user in the at least one desktop session of the shared computing resource environment;
recording the participation of the computer user in the at least one desktop session of the shared computing resource environment;
playing a saved recording of the participation of the computer user in the at least one desktop session of the shared computing resource environment;
sending a message to the computer user that is participating in the at least one desktop session of the shared computing resource environment; or
terminating the access of a computer user to the at least one desktop session of the shared computing resource environment.

18. A system, comprising:
one or more processors;
memory that includes a plurality of computer-executable components, the plurality of computer-executable components comprising:
an operating system module to support a shared resource computing environment;
a user interface module to establish direct input/output (I/O) connections to a plurality of user interfaces from the single computing device without using networking hardware or software components, each of the user interfaces including a display and one or more input devices to provide a corresponding computer user with access to the single computing device;
a desktop session module to launch at least one desktop session in the shared resource computing environment that is implemented on the single computing device; and
an administration module to enable an administrator to provide the plurality of computer users with concurrent access to an application that is executing in the at least one desktop session of the shared resource computing environment, the concurrent access includes at least one of simultaneous or sequential access to the application by the computer users via the plurality of user interfaces.

19. The system of claim 18, wherein the administration module is to further enable the administrator to manage interaction of the plurality of computer users in the at least one desktop session by at least one of:
terminating the at least one desktop session or an application in the at least one desktop session;
saving data and states of the at least one desktop session of the shared resource computing environment;
resuming the at least one desktop session of the shared resource computing environment that is saved; or
switching the at least one desktop session of the shared resource computing environment from executing the application to executing another application.

20. The system of claim 18, wherein the administration module is to further enable the administrator to manage the at least one desktop session by at least one of:
suspending participation of the computer user in the at least one desktop session of the shared computing resource environment, the participation includes at least one of interaction between the computer user and at least one other computer user or interaction of the computer user with the application executing in the at least one desktop session;
viewing in real time the participation of the computer user in the at least one desktop session of the shared computing resource environment;
recording the participation of the computer user in the at least one desktop session of the shared computing resource environment;
playing a saved recording of the participation of the computer user in the at least one desktop session of the shared computing resource environment;
sending a message to the computer user that is participating in the at least one desktop session of the shared computing resource environment; or
terminating the access of a computer user to the at least one desktop session of the shared computing resource environment.
